(19) United States
(12) Patent Application Publication
(10) Pub. No.: US 2026/0140283 A1
(43) Pub. Date: May 21, 2026

(54) METHOD OF DEVELOPING ANTIREFLECTION COATINGS VIA PLASMA ETCHING

(71) Applicant: TIPD, LLC, Tucson, AZ (US)

(72) Inventors: Valery Temyanko, Tucson, AZ (US); Viktor Dubrovin, Tucson, AZ (US); Adoum Mahamat, Tucson, AZ (US)

(21) Appl. No.: 19/395,852

(22) Filed: Nov. 20, 2025

Related U.S. Application Data
(60) Provisional application No. 63/722,789, filed on Nov. 20, 2024.

(51) Int. Cl. G02B 1/113; G02B 1/12

(52) U.S. Cl. CPC G02B 1/113; G02B 1/12

(57) ABSTRACT

A method of producing an anti-reflection substrate. A refractive index-matching coating is applied onto a surface of an optical substrate. The refractive index-matching coating is plasma etched to form a random patterned or textured surface on the coating that is configured to provide antireflection properties.

### CROSS-REFERENCE TO RELATED APPLICATIONS

This application is a non-provisional and claims benefit of U.S. Provisional Application No. 63/722,789 filed Nov. 20, 2024, the specification(s) of which is/are incorporated herein in their entirety by reference.

### FIELD OF THE INVENTION

The present invention features thin-film anti-reflection (AR) coatings, in particular, plasma etching of AR coatings on materials with certain mechanical properties and chemical durability, as well as on materials that are difficult to plasma etch.

### BACKGROUND OF THE INVENTION

The traditional approach to minimizing reflections from optical components and windows involves depositing multiple thin layers of dielectric materials onto their external surfaces. This well-established technique is known in the industry as thin-film anti-reflection (AR) coating. To obtain a broadband range of wavelengths over which reflections are suppressed, a large number of thin-film layers are necessary. Thus, for effective anti-reflection, a typical design might require more than 20 layers of material, accumulating a total thickness exceeding 10 microns.

However, the performance of thin-film AR coatings, where more than 99.9% transmission needed, is limited to situations where light strikes the surface along or near the system axis—that is, perpendicular to the window or optic's external surface. For off-axis incident light, these coating stacks can actually increase reflected light and introduce undesirable polarization effects.

Durability and thermal cycling pose significant concerns for multilayer thin-film AR coatings, especially with Coefficient of Thermal Expansion (CTE) mismatched materials. Inherent stress and adhesion issues can arise due to the differing thermal expansion coefficients of the layered materials. Temperature fluctuations can lead to loss of adhesion in the thin films, resulting in catastrophic failures of space-based infrared cameras and industrial lasers. In many military applications, multilayer thin-film AR stacks degrade and have short lifespans when exposed to solar radiation and harsh environments like rain and sand erosion. Additionally, the absorption and varying thermal dispersion in these stacks limit the achievable power in solid-state laser designs. For display applications, AR coatings are generally avoided due to issues with cost, limited lifespan, and performance problems such as narrow viewing angles, lack of durability, and adhesion loss.

A modern approach to reducing reflection losses is inspired by natural nanoscale structures such as the moth's eye. The moth-eye pattern and its variation and random texture antireflection (RAR) coating consists of subwavelength “bumps” that reduce reflection by creating an effective refractive index gradient between the air and the medium. Typical methods for antireflection nanostructure fabrication can be divided into the following: 1) Pattern etching on the window material using plasma etching; 2) Development of phase-separated borosilicate glass thin films made of a porous three-dimensional interconnected network with a nanostructurally modulated refractive index gradient (the closer to the substrate, the higher the index); and 3) Nano-imprinting lithography of the pattern onto a soft plastic material film applied onto a substrate. Each of these techniques have certain drawbacks limiting their application.

Plasma etching developed AR coatings show good performance achieving reflections losses of less than 0.1% on materials that tend to easily form volatile byproducts or have well established processes, such as SiO₂ (silicon dioxide), Al₂O₃ (aluminum oxide), silicate glasses, plastics, and polymers. Materials like Si₃N₄ (silicon nitride), GaAs (gallium arsenide), InP (indium phosphide), GaN (gallium nitride), and various photoresists also generally plasma etch well due to the formation of volatile etch products. However, some materials and materials containing them can form low-volatility compounds or might be damaged under plasma etching, like Ga₂O₃ (gallium oxide), as well as other oxides such as MgO (magnesium oxide), TiO₂ (titanium dioxide), ZrO₂ (zirconium dioxide), HfO₂ (hafnium oxide), Y₂O₃ (yttrium oxide), La₃O₂ (lanthanum oxide), CeO₂ (cerium dioxide), SrO (strontium oxide), Cr₂O₃ (chromium(III) oxide), Fe₂O₃ (iron(III) oxide), NiO (nickel(II) oxide), CuO (copper(II) oxide), WO₃ (tungsten trioxide), MoO₃ (molybdenum trioxide), SnO₂ (tin(IV) oxide), PbO (lead(II) oxide), MnO₂ (manganese dioxide), V₂O₅ (vanadium(V) oxide), In₂O₃ (indium oxide), and CdO (cadmium oxide).

These materials may suffer from low etching rates and uneven pattern etching, as well as issues such as surface roughness and residue formation, due to the formation of non-volatile byproducts that accumulate on the surface and inhibit further etching; thus making it difficult to develop the required patterns on materials containing the above oxides. In addition, since the developed patterns retain the properties of the bulk materials, plasma etching is not reliable for materials with low chemical durability characterized by sensitivity to water, atmospheric moisture, carbonates in the atmosphere, and weak acid or base solutions.

Phase-separated borosilicate glass thin films typically show excellent performance on fused silica and other low refractive index materials with refractive indices close to that of silica (approximately 1.45). This is because the gradual refractive index gradient provided by the porous, three-dimensional network of the phase-separated glass matches well with the substrate, effectively minimizing reflection losses across a range of wavelengths. However, when these films are applied to high refractive index materials, a significant mismatch occurs at the boundary between the phase-separated film and the substrate. This mismatch arises because the refractive index gradient of the film does not adequately bridge the larger difference between air and the high-index substrate. As a result, a portion of the incident light is reflected at the interface, diminishing the anti-reflective effectiveness of the coating. This effect is particularly notable in materials with high refractive indices such as sapphire (Al₂O₃), aluminum oxynitride (AlON), zinc sulfide (ZnS), zinc selenide (ZnSe), germanium (Ge), gallium arsenide (GaAs), silicon carbide (SiC), and diamond. These materials are commonly used in optical applications requiring durability and high thermal conductivity but present challenges for anti-reflective coatings due to their high refractive indices, which can range from about 2.0 to over 4.0. To mitigate this issue, alternative strategies may be necessary when working with high-index substrates.

Nano-imprinting lithography is a cost-effective alternative to the techniques described above for creating antireflective coatings and structures. It can achieve over 98% transmission across a broad spectral region. However, it is typically only suitable for applications that do not require high optical density or are not exposed to harsh conditions. This limitation arises because the nano-imprinted patterns are often made from polymer materials, which generally have weak mechanical properties, chemical durability, and temperature resistance compared to inorganic materials. Specifically, polymers are more susceptible to scratching, abrasion, degradation at elevated or low temperatures, and damage from UV light and high energy light sources exposure. These vulnerabilities make polymer-based antireflective structures less suitable for applications demanding high durability, such as those involving extreme mechanical film deposition. The thin film deposition may involve Physical Vapor Deposition (PVD), Chemical Vapor Deposition (CVD), Atomic Layer Deposition (ALD), Molecular Beam Epitaxy (MBE), or Pulsed Laser Deposition (PLD).

### BRIEF SUMMARY OF THE INVENTION

It is an objective of the present invention to provide devices and methods that allow for high-performance random anti-reflective (RAR) structures, as specified in the independent claims. Embodiments of the invention are given in the dependent claims. Embodiments of the present invention can be freely combined with each other if they are not mutually exclusive.

According to some embodiments, the present invention features an anti-reflection substrate comprising an optical substrate having a plasma-etched refractive index-matching coating disposed on a surface of the optical substrate. The plasma-etched refractive index-matching film may comprise a random patterned or textured surface that is configured to provide antireflection properties.

To overcome the limitations of previous methods, the present invention features a method of applying a single layer coating matching the refractive index of the substrate. In some embodiments, various methods for thin film deposition can be implemented, such as Physical Vapor Deposition (PVD), Chemical Vapor Deposition (CVD), Atomic Layer Deposition (ALD), Molecular Beam Epitaxy (MBE), and Pulsed Laser Deposition (PLD).

In some embodiments, plasma etching utilizes trifluoromethane (CHF₃), either alone or in combination with oxygen and/or argon. In other embodiments, plasma etching utilizes methane (CH₄), hydrogen (H₂), bromotrifluoromethane (CBrF₃), carbon tetrafluoride (CF₄), oxygen, sulfur hexafluoride (SF₆), or a chlorine-based gas. The chlorine-based gas may be silicon tetrachloride (SiCl₄) or boron trichloride (BCl₃).

In conjunction with or alternative to some embodiments, the refractive index of the optical substrate may be modified to match a refractive index of the preferred coating for its subsequent plasma etching.

### BRIEF DESCRIPTION OF THE SEVERAL VIEWS OF THE DRAWING(S)

The features and advantages of the present invention will become apparent from a consideration of the following detailed description presented in connection with the accompanying drawings in which:
FIGS. 1A-1C show a schematic of the present invention.

FIG. 2 shows a flow diagram for the method of the present invention.

FIG. 3 shows a prior art schematic of plasma etching.

### DETAILED DESCRIPTION OF THE INVENTION

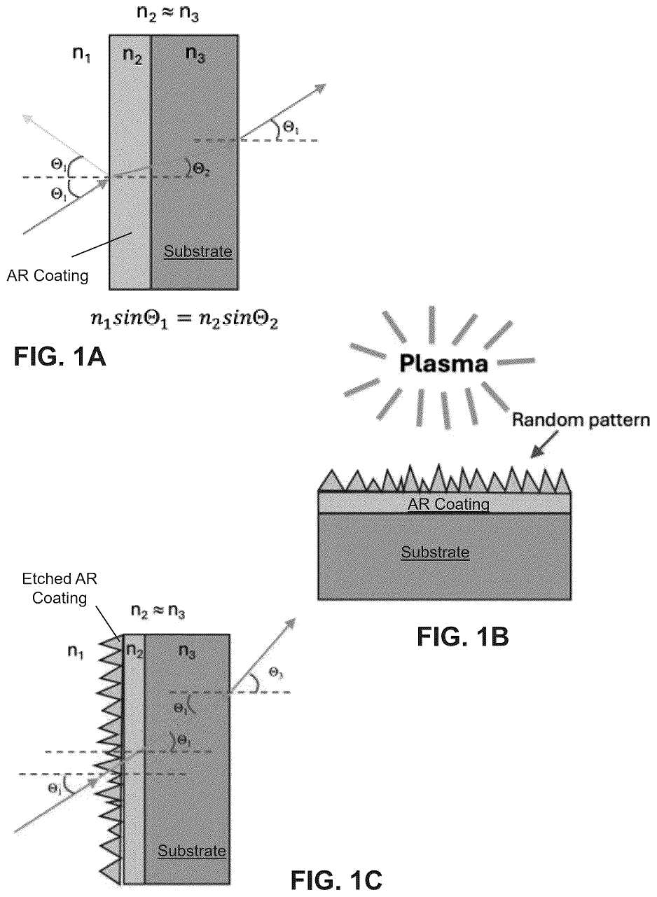

Referring now to FIG. 1A, the schematic shows an optical material coated with a refractive index-matching film, with ray traces shown. Since the coating and the substrate have the same refractive index, according to Fresnel's law, the boundary between the coating and substrate is invisible to passing light, thus no reflection occurs. In FIG. 1B, the refractive index matching film is plasma etched to produce random patterns. FIG. 1C shows the optical element (window) with RAR coating on one surface, with ray traces shown.

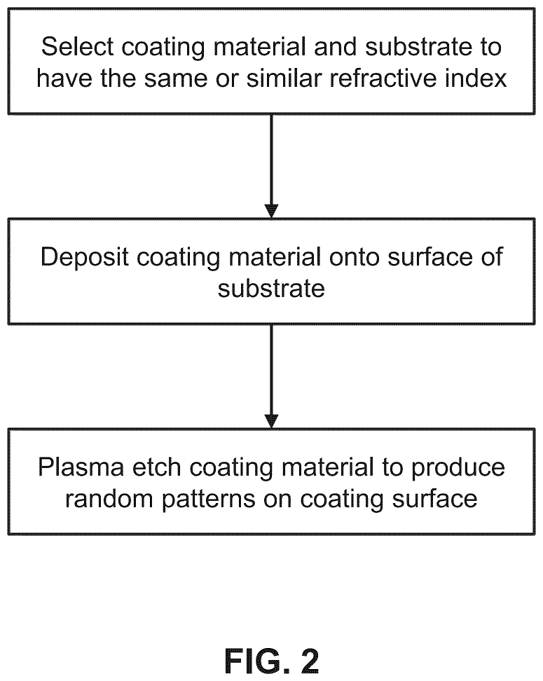

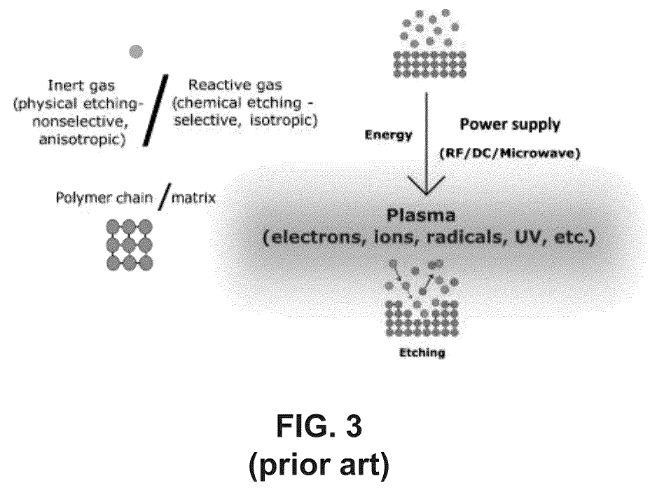

Referring to FIGS. 2-3, in some embodiments, the present invention features a method of producing an anti-reflection substrate. The method may comprise providing a substrate; applying an anti-reflection coating onto a surface of the substrate, where the anti-reflection coating is a refractive index-matching coating such that said coating and the substrate have a same or approximately same refractive index; and plasma etching the refractive index-matching coating. Without wishing to limit the present invention, the plasma etching forms a random patterned or textured surface on the coating that is configured to provide antireflection properties.

In some embodiments, the substrate may comprise a polymer or glass material. In other embodiments, the substrate is an optical substrate. Non-limiting examples of the substrate include lenses, glass windows, and solar cells.

In some embodiments, the refractive index-matching coating is applied using thin film deposition. Examples of the refractive index-matching coating includes, but is not limited to, SiO₂, Al₂O₃, ZnS, ZnSe, HgCdTe, or AlON.

In non-limiting embodiments, thin film deposition may comprise physical vapor deposition (PVD), chemical vapor deposition (CVD), atomic layer deposition (ALD), molecular beam epitaxy (MBE), or pulsed laser deposition (PLD). In some embodiments, plasma etching utilizes trifluoromethane (CHF₃), either alone or in combination with oxygen and/or argon. In other embodiments, plasma etching utilizes methane (CH₄), hydrogen (H₂), bromotrifluoromethane (CBrF₃), carbon tetrafluoride (CF₄), oxygen, sulfur hexafluoride (SF₆), or a chlorine-based gas such as silicon tetrachloride (SiCl₄) or boron trichloride (BCl₃).

In some embodiments, the anti-reflection substrate has a transmission >99%. In other embodiments, the anti-reflection substrate has a transmission >98%. In some other embodiments, the anti-reflection substrate has a transmission >97%. In yet other embodiments, the anti-reflection substrate has a transmission >96%. In some embodiments, the anti-reflection substrate has a transmission >95%.

According to some embodiments, the present invention features an anti-reflection substrate comprising an optical substrate having a plasma-etched refractive index-matching coating deposited on a surface of the optical substrate. In some embodiments, the plasma-etched refractive index-matching film may comprise a random patterned or textured surface that is configured to provide antireflection properties. Without wishing to limit the present invention, the refractive index-matching coating and the optical substrate may have the same or approximately the same refractive index. In further embodiments, a refractive index of the optical substrate may be modified to match the refractive index of the coating.

In some embodiments, the optical substrate may comprise a polymer or glass material. In other embodiments, the refractive index-matching coating may comprise SiO Al₂O₃, ZnS, ZnSe, HgCdTe, or AlON.

Without wishing to limit the present invention to a particular theory or mechanism, the main advantage of the proposed method over plasma etching for patterning a substrate is the ability to develop high-performance (transmission >99%) RAR structures on materials with weak mechanical properties and chemical durability, as well as on those that are difficult to plasma etch. Since the RAR structure is formed on a single-layer coating, the resulting optical components should have a significantly improved laser damage threshold compared to multilayer coatings, making them comparable to plasma-etched optics and phase-separated borosilicate glass thin films coated windows.

It should be noted that, in the described method, the film material can be selected to match the refractive index of the substrate material, and the material composition can be adjusted to achieve the preferred refractive index for the thin film. In conjunction with or alternative to some embodiments, the method may further comprise modifying a refractive index of the substrate to match a refractive index of the preferred coating for its subsequent plasma etching.

Standard deposition materials having known protocols for plasma etching as SiO₂, Al₂O₃, ZnS, TiO₂, MgF₂, HgCdTe, and AlON can be used as the coating layer. The coating later can be plasma etched to form a random pattern that provides anti-reflection properties.

In some embodiments, the standard reactive gas composition for etching random textures in glass or plastic is tri-fluoromethane (CHF₃), either alone or in combination with oxygen and/or argon. CHF₃ has been found to yield the highest density of features with the least amount of undercutting, allowing for precise pattern replication. Other gases that chemically attack substrate materials and are thus useful for creating random textured surface relief structures include methane (CH₄), hydrogen (H₂), bromotrifluoromethane (CBrF₃), carbon tetrafluoride (CF₄), oxygen, sulfur hexafluoride (SF₆), and chlorine-based gases such as silicon tetrachloride (SiCl₄) and boron trichloride (BCl₃).

### EXAMPLE

The following is a non-limiting example of the present invention. It is to be understood that said example is not intended to limit the present invention in any way. Equivalents or substitutes are within the scope of the present invention.

Example 1: An optical polycarbonate lens is coated with a layer of SiO₂. The surface of said SiO₂ layer is plasma etched using CHF₃ to produce an anti-reflective lens.

Example 2: A glass window is coated with a layer of SiO₂. The surface of said SiO₂ layer is plasma etched using CHF₃ to produce an anti-reflective glass window.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

What is claimed is:

1. A method of producing an anti-reflection substrate, comprising:
a. providing a substrate;
b. applying an anti-reflection coating onto a surface of the substrate, wherein the anti-reflection coating is a refractive index-matching coating such that said coating and the substrate have a same or approximately same refractive index; and
c. plasma etching the refractive index-matching coating.

2. The method of claim 1, wherein the plasma etching forms a random patterned or textured surface on the coating that is configured to provide antireflection properties.

3. The method of claim 1, wherein the substrate comprises a polymer or glass material.

4. The method of claim 1, wherein the substrate is an optical substrate.

5. The method of claim 1, wherein the optical substrate is a lens.

6. The method of claim 1, wherein the refractive index-matching coating is applied using thin film deposition.

7. The method of claim 6, wherein the thin film deposition is Physical Vapor Deposition (PVD), Chemical Vapor Deposition (CVD), Atomic Layer Deposition (ALD), Molecular Beam Epitaxy (MBE), or Pulsed Laser Deposition (PLD).

8. The method of claim 1, wherein the refractive index-matching coating comprises SiO₂, Al₂O₃, ZnS, ZnSe, HgCdTe, or AlON.

9. The method of claim 1, wherein plasma etching utilizes trifluoromethane (CHF₃), either alone or in combination with oxygen and/or argon.

10. The method of claim 1, wherein plasma etching utilizes methane (CH₄), hydrogen (H₂), bromotrifluoromethane (CBrF₃), carbon tetrafluoride (CF₄), oxygen, sulfur hexafluoride (SF₆), or a chlorine-based gas.

11. The method of claim 10, wherein the chlorine-based gas is silicon tetrachloride (SiCl₄) or boron trichloride (BCl₃).

12. The method of claim 1, wherein the anti-reflection substrate has a transmission >99%.

13. The method of claim 1, wherein the anti-reflection substrate has a transmission >95%.

14. The method of claim 1, further comprising modifying the refractive index of the substrate to match the refractive index of the coating for its subsequent plasma etching.

15. An anti-reflection substrate comprising an optical substrate having a plasma-etched refractive index-matching coating deposited on a surface of the optical substrate, wherein the plasma-etched refractive index-matching film comprises random patterned or textured surface that is configured to provide antireflection properties.

16. The anti-reflection substrate of claim 15 comprising a transmission >99%.

17. The anti-reflection substrate of claim 15, wherein the optical substrate comprises a polymer or glass material.

18. The anti-reflection substrate of claim 15, wherein the refractive index-matching coating and the optical substrate have the same or approximately the same refractive index.

19. The anti-reflection substrate of claim 15, wherein the refractive index-matching coating comprises SiO₂, Al₂O₃, ZnS, ZnSe, HgCdTe, or AlON.

20. The anti-reflection substrate of claim 15, wherein a refractive index of the optical substrate is modified to match the refractive index of the coating.
